(19) United States
(12) Patent Application Publication
(10) Pub. No.: US 2013/0058195 A1
(43) Pub. Date: Mar. 7, 2013

(54) DEVICE SYSTEM AND METHOD FOR GENERATING ADDITIVE RADIATION FORCES WITH SOUND WAVES

(71) Applicants: Guy CLOUTIER, Le Gardeur (CA); Anis Redha Hadj HENNI, Montreal (CA); Cédric Réne SCHMITT, Montreal (CA); Emmanuel MONTAGNON, Montreal (CA)

(72) Inventors: Guy CLOUTIER, Le Gardeur (CA); Anis Redha Hadj HENNI, Montreal (CA); Cédric Réne SCHMITT, Montreal (CA); Emmanuel MONTAGNON, Montreal (CA)

(21) Appl. No.: 13/537,322

(22) Filed: Jun. 29, 2012

Related U.S. Application Data
(60) Provisional application No. 61/502,414, filed on Jun. 29, 2011.

(51) Int. Cl. G01N 29/04

(52) U.S. Cl. 367/99

(57) ABSTRACT

The present relates to a device, a system and a method for generating radiation forces in a region of interest. For doing so, a plurality of additive shear waves are generated in the region of interest.

### FIELD

The present relates to elastography, and more particularly to a device, a system and a method for generating additive shear waves by induced adaptive radiation forces.

### BACKGROUND

Research in the field of breast cancer imaging to enhance specificity and sensitivity of diagnosis is intensive. Among emerging techniques of breast imaging, elastography is a very promising modality that could contribute, in complementarity with other imaging techniques, to reduce biopsies and facilitate early diagnosis.

Ophir et al. [Ophir, E. Cespedes, H. Ponneanti, Y. Yazdi and Li, “Elastography: a quantitative method for imaging the elasticity of biological tissue”, Ultrasonic Imaging, vol. 13, pp 111-134, 1991.] introduced static elastography in the early nineties. This method is based on external tissue compression combined with ultrasound imaging. Measurement of strains can be converted into elastic modulus but important assumptions on tissue properties must be done. In addition, this method is limited by artifacts related to unknown boundary conditions of the tissue to characterize.

Shear wave elasticity imaging was introduced by A. P. Sarvazyan, O. V. Rudenko, S. D. Swanson, J. B. Fowlkes, and S. Y. Emelianov, in “Shear wave elasticity imaging—A new ultrasonic technology of medical diagnostic,” Ultra. Med. Biol., vol. 24, pp. 1419-1436, 1998. This publication was based on the use of shear waves induced by an ultrasound radiation force. This radiation force was obtained by focusing an ultrasound beam inside the tissue for typically 100 μs to 400 μs. The displacement induced at the focus point was then used to evaluate local viscoelastic properties of the tissue. It was equivalent to providing the physician with a virtual finger to probe the elasticity of a tissue or a tumor.

J. Bercoff, M. Tanter, and M. Fink in “Supersonic shear imaging: A new technique for soft tissue elasticity mapping” IEEE Trans. on Ultrason. Ferrolec. Freq. Contr., vol. 51, no. 4, pp 396-409, 2004, proposed a technique named supersonic shear imaging that created cylindrical (or quasi-plane) shear waves of higher amplitude by moving the ultrasonic foci points faster than the shear wave speed at different depths on a straight line. Resulting shear waves interacted constructively along the Mach cone, creating, in the observation plane, two quasi-plane shear wave fronts propagating in opposite directions. This technique was combined with an ultra fast imaging capability required to track shear wave propagation within the tissue.

However, none of the prior art devices and methods provide a device and method capable of adapting the generation of radiation forces.

### SUMMARY

The present provides a device, a system and a method for generating radiation forces in a region of interest.

### BRIEF DESCRIPTION OF THE DRAWINGS

In the following description, the following drawings are used to describe and exemplify the present device and method:

FIG. 1 represents adaptive paths for radiation force generation to comply shear wave form in a region of interest, where FIG. 1a represents an adaptive strategy used to insure reorientation, in medium 1, of a plane shear wave generated in medium 2 and crossing a plane interface between both media, FIG. 1b represents another adaptive radiation force induction strategy to insure the propagation of a plane shear wave into medium 1 separated by a curved interface from the medium 2.

FIG. 2 is an example of a radiation force generation induced by multiple focusing of ultrasound following a circular path, where the total shear wave (a torsional wave in the present case) is obtained by the combination of the locally generated shear waves.

FIG. 3 represents a comparison of displacement amplitude maps and profiles obtained by different acoustic radiation force generation strategies into a homogeneous viscoelastic medium, where FIG. 3a is a displacement map resulting from the generation of radiation forces following a closed circular path, FIG. 3b is a displacement map resulting from the generation of radiation forces following a semi-circular path, FIG. 3c is the classical displacement map resulting from the generation of a radiation force in a single point, and FIG. 3d is a comparison of two displacement profiles, obtained by two different radiation force generation strategies into the same medium following circular and semi-circular paths, with the classical single point generation method for comparison.

FIG. 4 represents normalized stationary shear wave displacement maps, where FIG. 4a depicts interaction of a 500 Hz additive torsional shear wave generated by 2D radiation forces following a circular path (80 mm diameter) with two hard mechanical heterogeneities identified with circles, and FIG. 4b depicts interaction of a 275 Hz convergent and off-centered torsional shear wave generated by 2D radiation forces following a circular path (80 mm diameter) with a soft mechanical heterogeneity at resonance (i.e. with the method identified as Shear Wave Induced Resonance (SWR), see International Patent Application WO 2010/012092).

FIG. 5 is a schematic representation of a system for adaptive radiation force generation within a region of interest surrounded by the ultrasound focusing phased array.

FIG. 6 is a schematic top view of an exemplary device for adaptive radiation force generation within a region of interest surrounded by the ultrasound focusing phased-array.

FIG. 7 is the top view of the piezocomposite layer of one transducer.

FIG. 8 is a close up view of FIG. 7.

FIG. 9 is a partial side elevation view of a transducer used for a prototype of the present device.

FIG. 10 is an example of another method for generating adaptive radiation forces with single element transducers fixed on a cart moving along a linear guide way. Each transducer has a fixed focus length. Each transducer is activated to fire when it reaches a given translational position. In the present case, all transducers are activated in a selected position to generate a cylindrical wave into the medium.

FIG. 11 is a possible configuration of the cart. Excitation device is surrounded by two ultrasound imaging devices to combine radiation force excitation and ultrasound probing to measure low-frequency shear waves propagation.

FIG. 12 is an example of a possible sequence of firings for the example typified in FIG. 10. Single element transducers fire successively during cart motion when they reach a selected translational position. In this example firings occur at various depths but along a single linear path.

FIG. 13 is an example of a cart guided in a circular track. Each single element transducer has a fixed focus length. Each transducer is activated to fire when it reaches a given position. In the present case, multiple cylindrical waves can be generated along the track, leading to an increased amount of energy at the center of the ring within a region of interest of a tissue to characterize.

FIG. 14 is an example of a single arm device. The arm rotates and the transducer fires inside the volume of interest at various positions, allowing multiple mechanical excitations.

FIG. 15 shows examples of configuration of sequences for arm devices. Imaging devices are mounted above and below the excitation device in (a). Imaging devices are mounted besides of the excitation device in (b).

FIG. 16 is a possible sequence of firings along a circular track. Sequence begins with cart at position 1. Other firings occur during cart motion at positions 2,3 and 4. Firings can be triggered using sensors fixed along the track or using user defined commands of an electronic device or a computer. Under certain conditions related to the cart speed, Cerenkov's effect can be observed. Some cart configuration possibilities are presented in FIGS. 17 and 18.

FIG. 17 depicts an example of a two-arms device. Arms are face-to-face and transducers fire inside the volume of interest at various positions while the whole device is rotating. The two-arms device allows reducing rotation speed and increasing versatility of excitation paths. Arms configurations such as presented in FIG. 15 allow mechanical Sexcitation and imaging for this device.

FIG. 18 depicts an example of a four-arms device. Arms are equally spread along the 360°. The four-arms device allows reducing rotation speed and increasing versatility of excitation paths. Configurations such as presented in FIG. 15 allow mechanical excitation and imaging for this device.

FIG. 19 depicts a 2D matrix of transducers, which constitutes another method for generating adaptive radiation forces.

FIG. 20 is a schematic representation of a region of interest (ROI), the probed medium, and of an ultrasound 2D phased-array positioned at the contact of the ROI. This 2D probe generates local radiation pressures at different positions following the z-direction. The superposition of each radiation pressure induces cylindrical shear waves shearing the ROI in the z-direction (z-direction polarization).

FIG. 21 is a schematic representation of a region of interest (ROI), the probed medium, and of an ultrasound 2D phased-array positioned at the contact of the ROI. This 2D probe generates local radiation pressures at different positions following the z-direction and for two generation lines (dual-lines). The superposition of each radiation pressure induces cylindrical shear waves shearing the ROI in the z-direction (z-direction polarization) with an amplification of these waves between the two lines of generation.

FIG. 22 is a schematic representation of a region of interest (ROI), the probed medium, and of an ultrasound 2D phased-array positioned at the contact of the ROI. This 2D probe generates local radiation pressures at different positions following the z-direction and for many generation lines (multi-lines). The superposition of each radiation pressure induces cylindrical shear waves shearing the ROI in the z-direction (z-direction polarization) with an amplification of these waves at the center of the line of generation (a). Using the multi-lines strategy, it is also possible to create a plane shear wavefront (b).

FIG. 23 shows examples of shear wave generation using groups of firing transducers constituting the 2D phased-array. The spot of the induced radiation pressure is out-of-plane (x-y plane) and the circle is a projection of this point in the 2D phased-array plane. The size of the radiation pressure spot is inversely related to the number of firing transducers.

FIG. 24 is a graphical representation of the transducer impedance in water versus frequency allowing generating adaptive radiation forces for one configuration of the present system, device and method. The present system, device and method are not limited to this technical specification.

FIG. 25 is a graphical representation of harmonic impedance in vacuum versus frequency with the geometry of the transducer for on configuration of the present system, device and method.

FIG. 26 represents ultrasonics beams successively focused along a circle to generate adaptive radiation forces (the acoustic intensity is in W/cm²).

### DETAILED DESCRIPTION

Non-invasive ultrasound imaging based on classical methods such as B-mode, M-mode, Doppler mode, tissue harmonic mode, etc. . . . has a limited impact imaging to assess mechanical properties of tissues. Moreover, it is used for various applications such as gynecology, radiology, cardiology and neurology, but the efficiency and accuracy of interpretation depend to a great extent on the medical professional performing and interpreting the imaging results.

Ultrasound imaging can be used for several other applications, such as, for example, the detection of cancers. Development of breast cancer tumors induces substantial variation of biological tissue shear modulus. Therefore, tissue shear modulus measurement could be used in earlier diagnosis and supplemental classical ultrasound imaging modalities.

Dynamic elastography using ultrasound radiation force is a suitable approach for biological tissue shear modulus evaluation. To increase the elastographic image quality, the present invention proposes a device, a system and a method of shear wave generation based on adaptive acoustic radiation force for dynamic elastography imaging of soft tissues. The device, system and method generate versatile, geometrically and mechanically adaptive and complex shear wave fronts. This is done in the present device, system and method, by combining, in a constructive way, multiple elementary shear waves, to form more efficient and intensive shear wavefronts. Thus, by use of shear waves, the present device, system and method enhance mechanical response of tissues and elastographic quality of images. Furthermore, shear waves produced by the present device, system and method may be used to induce resonance of confined pathologies with the SWIR method. For doing so, the present device, system and method may generate radiation forces in set of points following a closed path around a region of interest (for example a tumor), in order to induce resonance elastography of the region of interest and/or increase displacement magnitudes induced by low frequency in-going shear waves.

Thus the present device, system and method can be used to perform dynamic elastography, shear-wave elasticity imaging, and/or shear-wave induced resonance elastography.

The present device, system and method permit considerable enhancement of low frequency vibrations into tissues while respecting safety limitations.

### Generation of Adaptive Radiation Forces

Generation paths of radiation forces can be adapted to generate shear waves with predetermined waveforms. For example, when the radiation forces are induced following a circular path, the generated shear waves into a soft medium are additive torsional waves. It is thus possible to induce radiation forces following properly selected paths to force the generated shear waves to comply, after propagation, to a given waveform in a given region of interest (ROI).

This technique is interesting in the context of dynamic elastography imaging. Indeed, during the propagation, shear waves interact with biological tissues, which can present localized or extended mechanical heterogeneities. These heterogeneities can be due to the presence of abnormal pathological tissues or to the presence of healthy physiological tissues presenting mechanical contrasts (like fat and parenchyma soft tissues in the context of human breast). The present device, system and method adapt the radiation force induction path to generate adaptive shear waves interacting with the healthy mechanical heterogeneities during propagation in order to produce a given waveform in a given ROI.

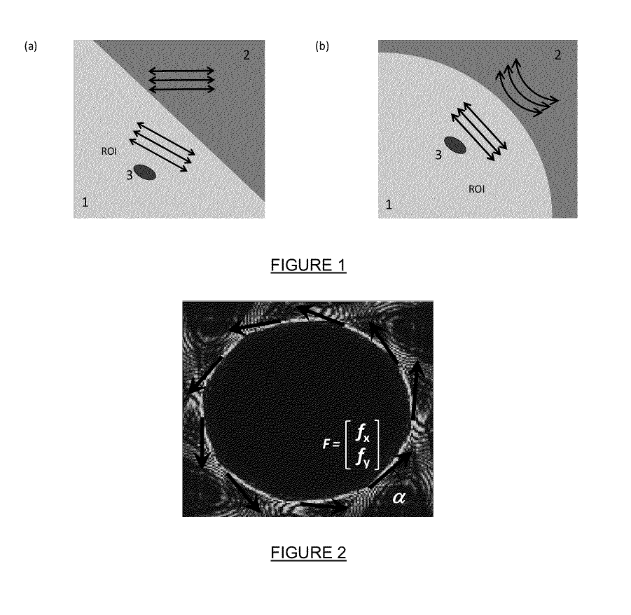

Examples of generated shear waves are given in FIG. 1. In FIG. 1.a, a plane shear wave is generated in medium 2 by mean of radiation forces. This plane wave is generated in medium 2 with a suitable angle in order to correctly interact with a linear material interface (between media 1 and 2, which present a mechanical contrast) and gets a given propagation direction in medium 1 (for example, polarization of waves parallel to the long axis of the heterogeneity 3). In the present case, the well-known Snell—Descartes law can serve to adapt the generation path in medium 2 to get the desired refraction at the interface and, consequently, the suitable direction of propagation in medium 1.

A second example of adaptive radiation force is given in FIG. 1.b. In this case, media 1 and 2 have a mechanical contrast and are separated by a curved interface. To generate a plane shear wave propagating in the region of interest (medium 1) by inducing radiation forces in medium 2, an adaptive radiation force induction consists in generating radiation forces following a circular path having an inverse curvature with regards to the interface curvature. Following the physical principle of wave diffraction, the obtained propagating shear waves interact with the curved interface to get a plane shape in medium 1. Obtaining a plane shear wave is not essential, but facilitates the implementation of physical models allowing to predict viscoelastic properties of the targeted object 3 within the ROI.

Ultrasound focusing permits, under certain conditions of duration and intensity of transmitted waves, to generate propagating low-frequency shear waves. The present aspects of adaptive radiation force induction allow concentrating ultrasound power at different localizations to generate elementary shear waves (i.e., a low frequency wave generated by the push of a single radiation force in a spatial position into a medium). The constructive interactions (or combinations) of these elementary shear waves result in the formation of more complex and efficient wave fronts able to converge in a given region of interest (see e.g., FIG. 2). Physically, by knowing the locally concentrated ultrasound power, it is possible to calculate the locally induced radiation force, which depends on the medium mechanical properties (like attenuation, celerity, non-linear properties, reflecting and scattering properties, etc. . . . ). The induced force amplitude can be modeled as described by A. P. Sarvazyan et al., ‘Shear wave elasticity imaging a new ultrasonic technology of medical diagnostics’, Ultrasound in Med. & Biol., Vol. 24, No. 9, pp. 1419-1435, 1998, or O. V. Rudenko et al., ‘Acoustic radiation force and streaming induced by focused nonlinear ultrasound in a dissipative medium’, J. Acoust. Soc. Am. 99 (5), May 1996, by using the following equation:

$$F ( x , y ) = \frac{2 α}{ρ c} I \qquad ( 1 )$$

where α is the medium acoustical attenuation, ρ is the density, c is the ultrasound celerity into the medium and I is the ultrasound acoustical intensity locally concentrated. Depending on the orientation of the focused ultrasound beam (i.e., depending on the focusing and apodization schemes), the induced force vector will have a given direction in the three-dimensional system of coordinates.

The local induction of radiation force results in the generation of an elementary shear wave. For example, if a homogeneous and isotropic medium is used, the Navier wave equation governs the low frequency shear wave generation and propagation, as:

(λ+2μ)∇(∇·U)−μ∇×(∇×U)+ρω²U=F(x,y) (2)

In this equation, λ and μ are Lamé coefficients, U is the vector displacement field and F(x,y) is the radiation force vector, which acts as a source term in the model. The total displacement field due to a set of localized sources is obtained by the combination of the different elementary displacement fields.
Dynamic Elastography Imaging Based on Adaptive Radiation Forces to Generate Shear waves

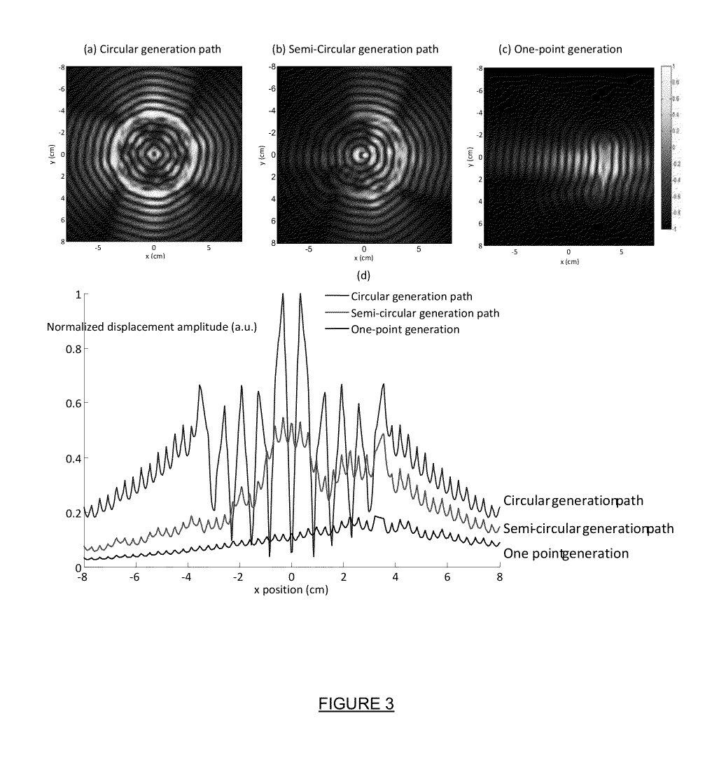

The present device, system and method offer the needed versatility in medical imaging to generate arbitrary low-frequency shear waves to perform elastographic imaging. Examples of this versatility and efficiency in enhancing mechanical response are given in FIG. 3. Here, the classical single point radiation force generation (FIG. 3.c) is compared with two other configurations for generating adaptive radiation forces obtained into the same medium following a circular (FIG. 3.a) and a semi-circular (FIG. 3.b) paths. Based on the superposition of displacement profiles (FIG. 3.d), it can be observed that the focusing method enhances the mechanical response of the imaged medium. For these examples, shear wave fields obtained by focusing are 5 to 10 times more important than the classical single point generation method.

The present device, system and method thus rely on new strategies to increase the elastographic image quality by using additive shear waves generated by two-dimensionally (2D) composed acoustic radiation forces along arbitrary paths surrounding a ROI (any body region or sub-region, such as for example a particular region or a pathology like a breast tumor). Use of additive shear waves generated by two-dimensionally composed acoustic radiation forces permits to considerably enhance low frequency vibrations into tissues while respecting safety limitations. Thus the present device, system and method are adapted for focusing and/or imaging a region of interest by means of acoustic radiation forces in the form of shear waves.

### System

Reference is now made to FIG. 5, which is a schematic representation of a system for adaptive radiation force generation. The present system comprises an ultrasound scanner and a computer that control all the system. An excitation signal is sent to a voltage generator. An output voltage (from the voltage generator) is amplified by a multichannel amplifier. Each channel of the amplifier is connected to an ultrasonic transducer of a particular ultrasound probe: a focusing phased-array ultrasound probe. The ultrasound probe is connected to the voltage generator through an amplifier and an impedance mismatch electronic board. Time delays and apodization weights determined by the computer are applied by the amplifier and impedance mismatch electronic board, in order to direct the ultrasound field at a given point for a given orientation and for a given value of acoustic intensity at a focus point within the region of interest. The radiation force is generated by transducers of the ultrasound probe, and induces shear wave propagation into the tissue.

Finally, an ultrafast imaging system is employed to measure shear wave propagation. Any other technologies, such as magnetic resonance imaging can be used to track shear wave motions.

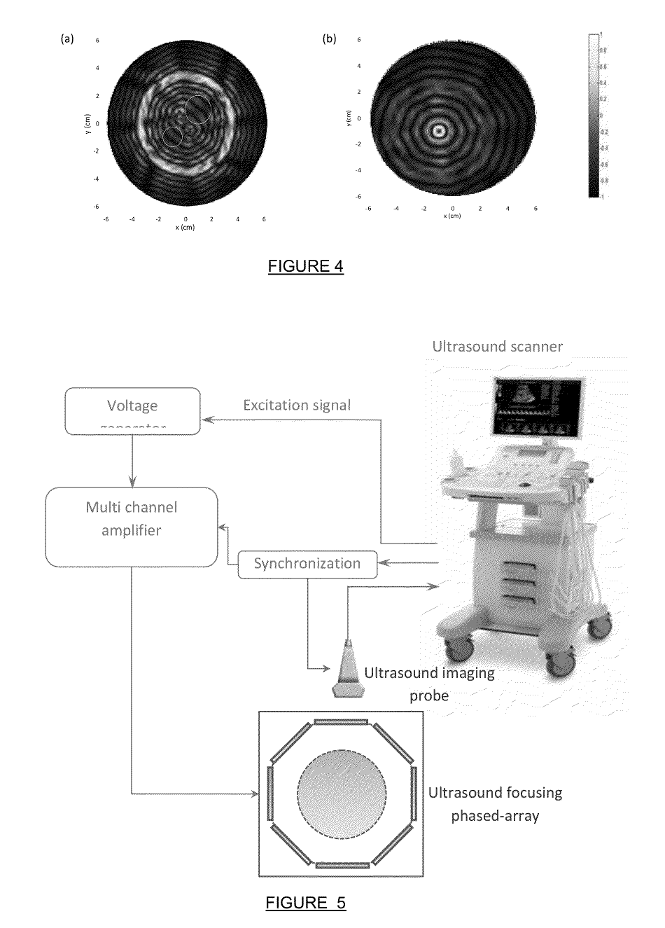

FIG. 4 illustrates two different cases of interactions between shear waves induced by 2D radiation forces, following a circular path, and hard (a) or soft (b) mechanical heterogeneities into a mimicked breast.

Induced shear waves presented in FIG. 4 are obtained by converging multiple shear waves by means of the present device and system to induce radiation forces following a circular path into the imaged medium. This example shows the effect of 2D radiation forces in the context of breast tumor elastography. By soundly concentrating the shear wave energy, the gain in amplitude permits to enhance elastographic image quality and contribute to perform precise viscoelastic characterization and mapping. This characterization may be realized by any inversion algorithms like inverse problems solving, shear wave induced resonance, spectral inversion and analysis, shear wave time of flight analysis, acoustic radiation force impulse imaging, etc. . . . In order to insure an optimal shear wave convergence, the present device, system and method generate additive shear waves following adaptive paths by properly considering the region of interest (i.e. the tumor shape, position and/or the viscoelastic spatial contrast of the media, etc. . . . ).

The present system can thus generate radiation forces along a region of interest using a specially designed device, i.e. an ultrasound probe such as for example the octagonal phased-array shown in FIG. 5. Additionally, the present system may focalize the generated radiation forces at one particular point or within the region of interest, by controlling the orientation and magnitude of the radiation forces generated by the device. The present system may further generate radiation forces along a closed or open path inside the region of interest, by controlling the orientation and magnitude of the radiation forces generated by the device in such a way as to generate an in-going wave.

### Device

Several devices may be used for generating additive radiation forces for dynamic elastography imaging. Their main function is to remotely induce shear waves in soft media using ultrasonic radiation forces. The radiation force concept relies on focusing ultrasonic waves in order to concentrate energy and thus to induce physical displacements in the insonified medium. Applying different focal point in various successive positions allow to generate complex wavefronts, and under certain conditions to reproduce the Cerenkov's effect in the propagation medium. Main advantages of such concepts are their mechanical, electronical simplicity, and configuration versatility. Indeed, excitation and imaging can be performed simultaneously by each device.

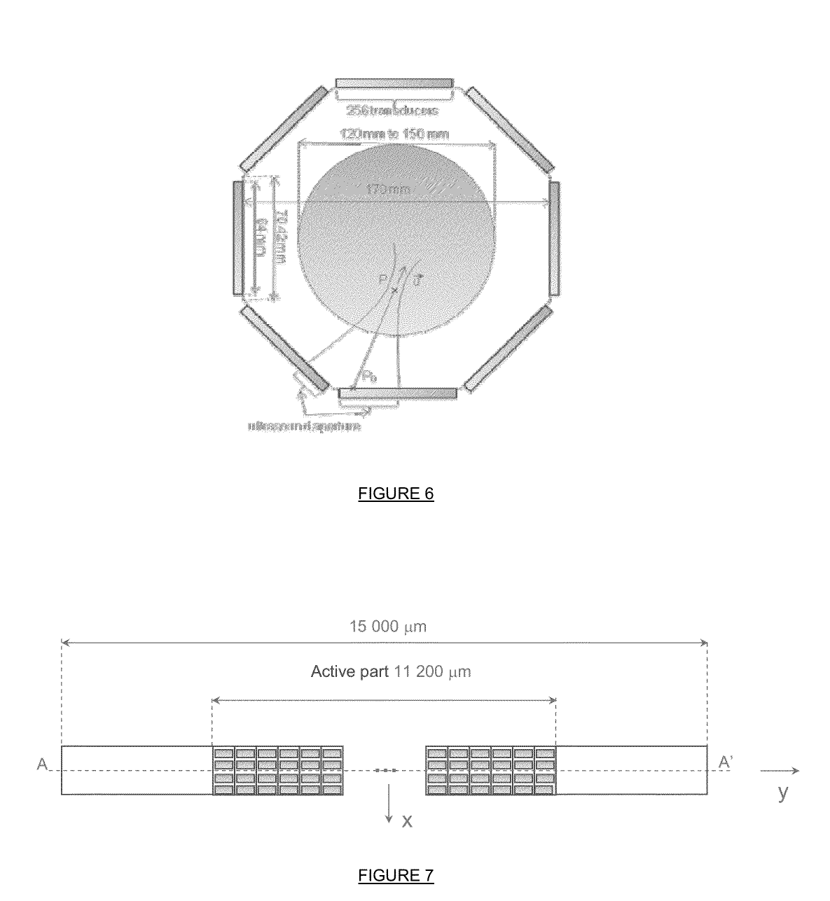

Various embodiments of devices may be used to generate radiation forces along a closed or open path inside the region of interest. For doing so, the device comprises a plurality of ultrasound probes. Each ultrasound probe comprises a plurality of transducers, where each transducer is adapted for generating a two-dimensional acoustic radiation force. The plurality of ultrasound probes generates by means of their respective transducers and their respective geometry around the region of interest, concurrent additive or constructively interacting shear waves in the region of interest. Although in the present FIGS. 5 and 6, the device is represented as an octagonal phased array, the present device is not limited to such an implementation, and could be realized in various geometries, for example circular, rectangular, hexagonal, square, etc. . . . , all permitting generation of radiation forces inside the region of interest.

FIG. 6 shows an example of a cross section view of the octagonal phased-array around a breast. P is the focus point, located inside the breast. The unit vector u defines the radiation force (or acoustic axis) orientation. P0 is a point located at the center of a transducer so that POP is parallel to the acoustic axis. To generate the radiation force at point P, only the transducers located in the ultrasound aperture are activated. Voltages and time delays are determined by the computer, and specific voltage as determined by the computer is applied to each transducer of the ultrasound aperture.

Thus, in the present example of device, each edge of the octagonal phase-array is a linear phased-array with 256 transducer elements. The total number of transducer elements is 2048.

For example, in an aspect, the present device is an ultrasound multi phased array surrounding (totally or partially) the imaged medium for multiple acoustic radiation force induction following an arbitrary generation path.

In another aspect, the present device is an ultrasound phased array or a set of mono-element transducers moving mechanically at a suitable velocity, in translation or rotation, on or near the imaged medium to induce adaptive radiation forces and low-frequency shear waves.

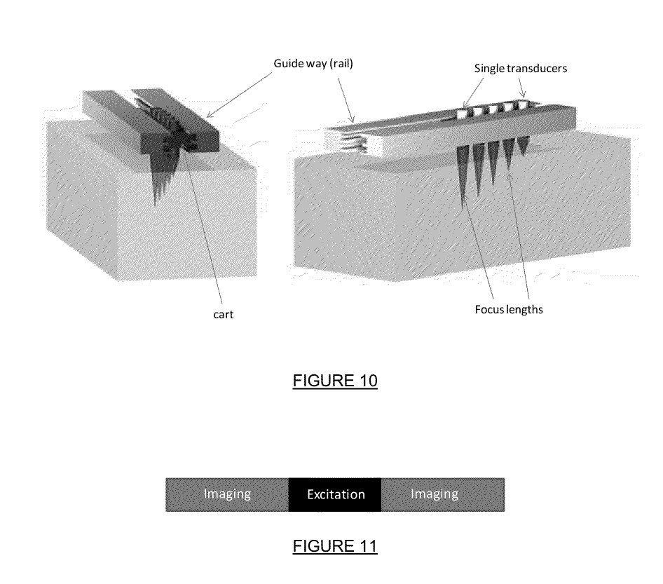

In yet another aspect, the present device is a two-dimensional ultrasound phased array generating into the tissue out-of-plane shear waves by adaptive radiation forces along arbitrary paths surrounding a tissue/breast tumor. An example of such a device is shown in FIG. 10, in which few single element transducers (5 in the present case) are fixed on a cart, this latter having constraint displacements in a linear guide way. Each single transducer has a fixed focal length. Cart motion and suitable synchronization of transducers firings allow multiple excitations at different depths to generate complex wavefronts. Cart motion can be performed using any of the following: an electric motor, electrodynamic levitation method, or any other method which allows the motion of the cart holding the transducers.

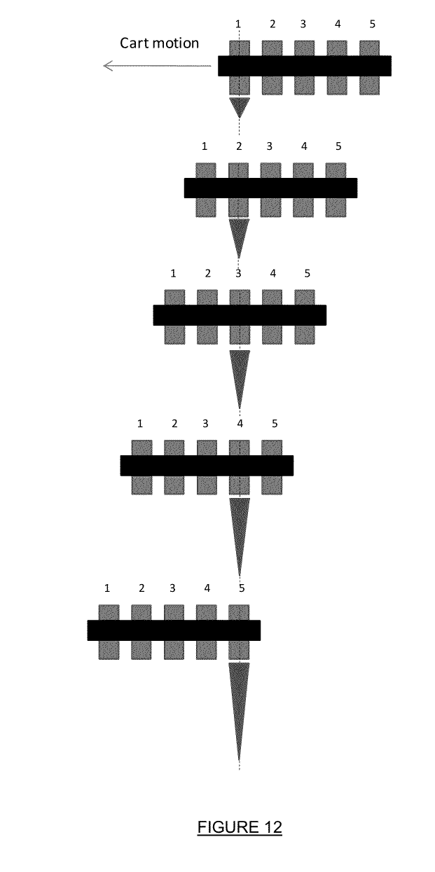

As shown in FIG. 12, synchronization of the transducers firings can be controlled with user specifications employing a dedicated configuration of transducer commands, or using a sensor fixed on the guide, way which triggers the moving transducer when they are face-to-face. The device can be upgraded placing linear array transducers besides of the single transducers for an imaging purpose.

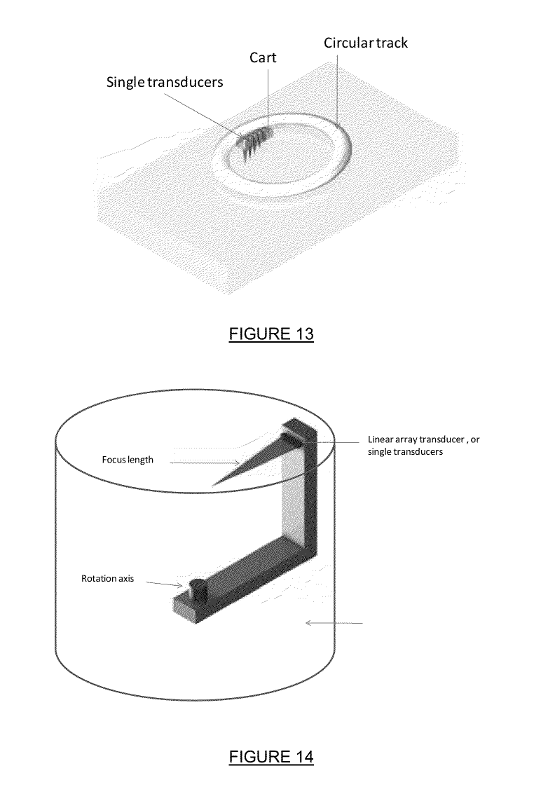

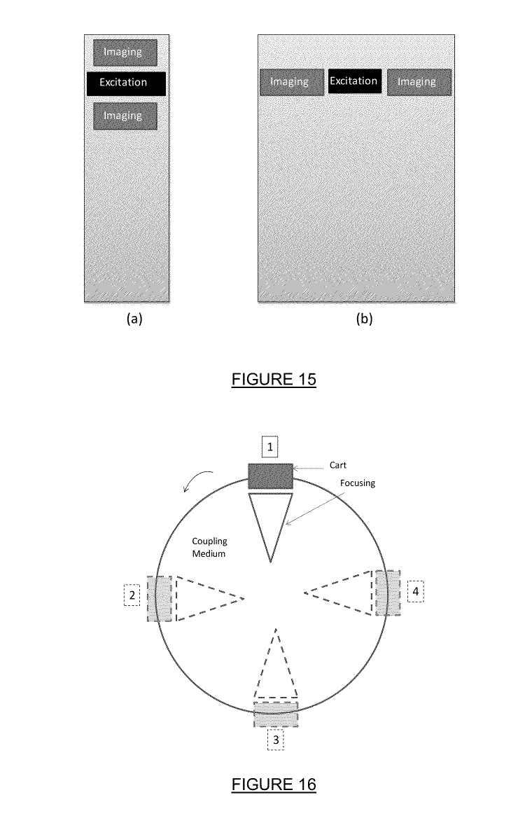

Referring now to FIG. 13, there is depicted another example of the present device. This particular example is an extension of the device of FIG. 10, which uses a circular track instead of a straight one. Cart's motion is circular, allowing faster displacement speeds, and multiple mechanical excitation locations along the track. Cart configuration, motorization and synchronization are the same as those suggested for the device of FIG. 10.

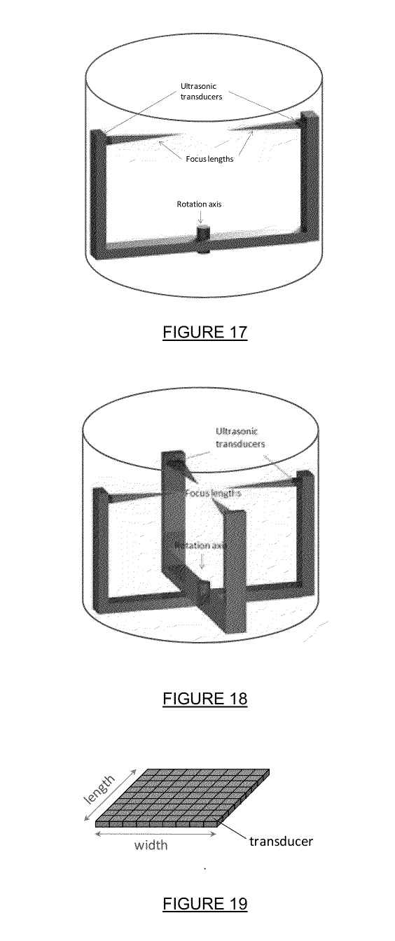

The devices presented in FIGS. 10 and 13 are dedicated to the generation of shear waves in soft media. Remotely induced torsional waves are generated by applying radiation forces at discrete points along a predefined closed path. Therefore, basic principle of devices presented below is to use rotating curved arms (right-angled or not), on which are mounted linear array transducers, or array of few single element transducers such as presented below, to induce radiation force in the volume of interest at various locations and various directions. The following devices presented in FIGS. 14, 17 and 18 differ only on the number of arms used. Multiplying arm number allows reducing rotation speed and increasing number of excitation locations (complex paths are accessible). Using linear array transducers permits more flexibility on excitation path since focus length can be adjusted using beamforming techniques, instead of single transducers which have fixed focus depths. Assuming controlled vertical translation of the rotation axis of the device in FIGS. 14, 17 and 18, a three-dimensional region of interest is reachable. Linear arrays of transducers can be fixed besides the excitation devices on each arm for imaging purpose. Few sequences configurations are suggested in FIGS. 12 and 16.

Another aspect of the present device is based on 2D ultrasound phased array probes. The proposed probe is composed of a 2D matrix of transducers (FIG. 19). This rectangular or squared transducer matrix is build from a set of single piezocomposite ultrasonic transducers, CMUT (Capacitive Micromachined Ultrasonics Transducers) or PMUT (Piezoelectric Micromachined Ultrasonics Transducers). This phased array is well dedicated to generate a radiation pressure according to different firing strategies.

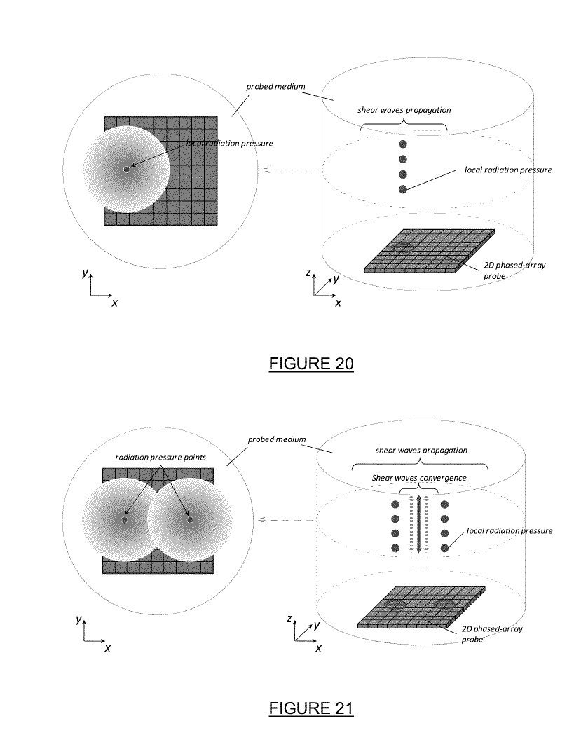

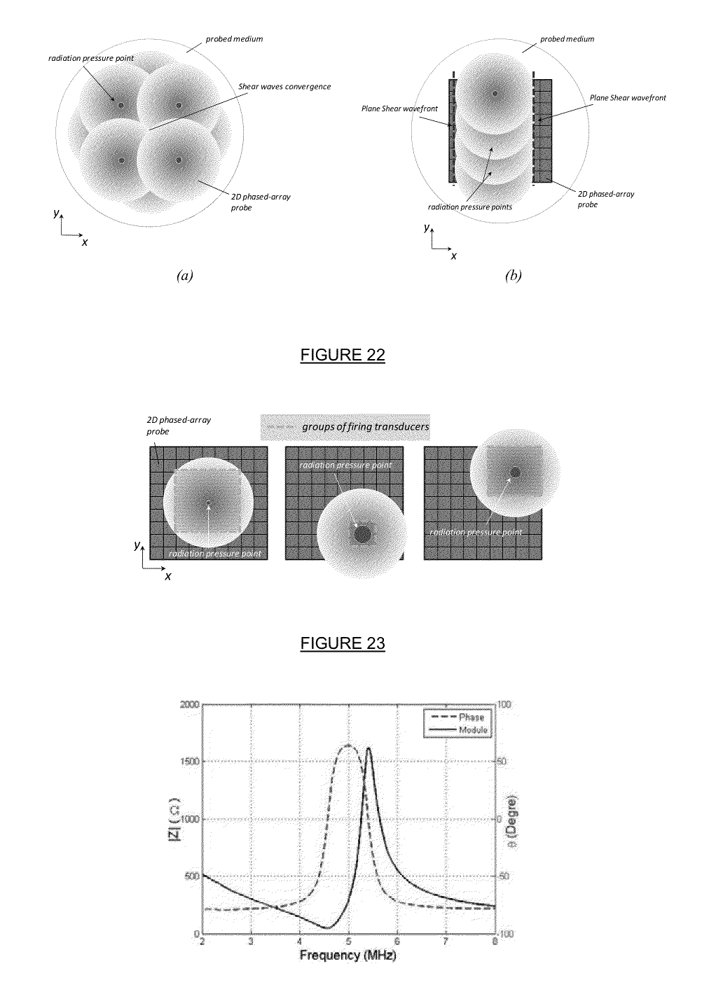

The device of FIG. 19 generates induced radiation forces following a direction perpendicular to the probe surface (i.e. the z-direction), or at an arbitrary-angled direction, at different positions in this direction (FIG. 20). These multiple radiation sources generate cylindrical shear waves polarized in the direction of the radiation pressure point displacements (z-direction in FIG. 20). More generally, the present device can be adapted to a dual-line (FIG. 21) or multi-lines (FIG. 22) radiation pressure. As presented in FIG. 22.a, the last configuration has the advantage to generate shear waves contained on a cylindrical-shape surface and polarized in the z-direction. Moreover, this method is also capable to generate shear waves contained on a 2D plane (y-z plane in FIG. 22.b).

To properly generate radiation pressures in term of localization and spot size, the strategy of the transducer command consists in firing transducers contained in pre-defined region (i.e. squared, rectangular, discretized circle, etc. . . . ). Examples illustrated in FIG. 23 show the radiation pressure spot size as a function of the size of the firing transducers group contained in a squared region.

In another aspect, the present device is an ultrasound probe that generates radiation forces in set of points of a tissue to be diagnosed. The ultrasound probes generate radiation forces following a closed path in the tissue/tumor in order to induce resonance elastography of the tissue/tumor and/or increase displacement magnitudes induced by low frequency propagating shear waves.

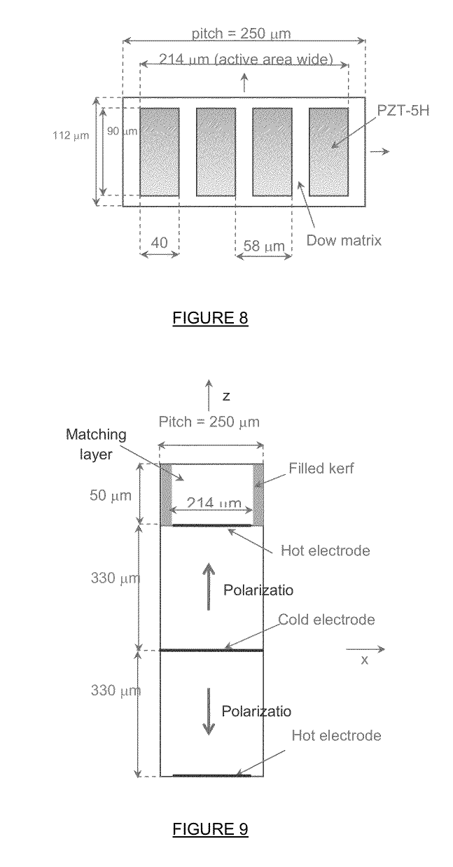

Reference is now made to FIGS. 7, 8 and 9, which schematically depict an exemplary construction of the transducers of the present device.

1-3 piezocomposite with 55% fraction volume (v) of PZT-5H and 45% fraction volume of Dow polymer is used as active material. These Figures shows details of the top view cross section of the piezocomposite.

The transducer is composed of: two piezocomposite layers with opposite polarization, one matching layer (0-3 composite with 80% Hysol and 20% Al2o3), two filled kerfs, two hot electrodes and one cold electrode, one backing, and one air cavity between the piezoelectric layers and the backing.

However, the present transducers could alternately be manufactured with piezocomposite ultrasonic transducer technology, micromachined ultrasonic transducer technology, CMUT, etc. . . .

### Method

In another aspect, the present invention relates to a method for generating radiation forces. The method identifies a plurality of additive shear waves; determines direction and magnitude of parallel two-dimensional acoustic waves for each additive shear waves, and generates the parallel two-dimensional acoustic waves with the determined direction and magnitude for each identified shear waves. The method corresponds to modes of functioning of the system and the various aspects of devices.

### Prototype

A numerical prototype was created to demonstrate the feasibility of an ultrasound probe to generate ultrasound radiation forces in set of points following a path (closed or open) around a region of interest in order to induce resonance elastography of that region of interest and/or increase displacement magnitudes induced by low frequency propagating shear waves. To achieve this, a high sensitivity octagonal phased-array of 8 sub-probes with 256 transducer elements each, for a total of 2048 transducer elements was designed. It produced acoustic intensity above 160 W/cm² at several foci points simultaneously, and generated ultrasound radiation forces. Transducer's resonance frequency was set at 4.6 MHz. The transducer electrical impedance without cable at the resonance frequency was targeted to 50Ω in order to match the electrical impedance of standard electrical termination.

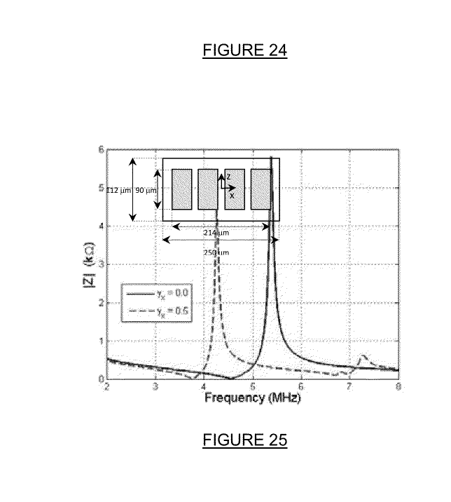

Using such a device, the ultrasound propagation in water was simulated to calculate radiation forces induced by multi-beam focusing (shown in FIG. 24). The electrical impedance (module & phase) as a function of frequency is displayed. Electroacoustic parameters are given as follows: C₀ is the static capacitance set at 80.37 pF, Fr and Fa are resonance and antiresonance frequencies set respectively at 4.56 MHz and 5.41 MHz, kt is the thickness mode coupling factor which was set at 0.57, |Z(Fr)| is the electrical impedance module at the resonance frequency set at 49.73Ω, Fc is the central frequency set at 4.58 MHz, BW is the transducer bandwidth set at 10.3%, LCF (@ −6 dB) is 4.34 MHz and HCF (@ −6 dB) is 4.81 MHz are low and high cutoff frequencies at −6 dB of the radiated power and Pw is the ultrasound radiated power at the central frequency set at 7.18 mW/1 Volt AC.

This device permitted to fully control the localization, orientation and amplitude of the induced mimicked pressure field and allowed to produce, following an arbitrary closed path, multiple and localized radiation forces. Using the finite element method (FEM) to solve equation (2), torsional shear waves induced by the radiation force patterns were studied and their interactions with breast mechanical heterogeneities were observed. Shear Wave Induced Resonance (SWIR) elastography of breast lesions is also possible using the strategy proposed by Hadj Henni A., Schmitt C., Montagnon E., Cloutier G., Shear induced resonance for dynamic elastography and material characterization, and published in the International Patent Application WO 2010/012092.

Because it has a high coupling factor and due to the fact that its mechanical impedance can be tailored to optimize acoustic power transmission into a tissue, the 1-3 piezocomposite material was used as active material. Several materials were tested to achieve the targeted application, and other materials could alternately be used for the present device.

With regard to its high electromechanical coupling factor and dielectric constant as described by D. Berlincourt et al. in “Properties of Piezoelectricity Ceramics Mapping”, Morgan Electro Ceramics Web Site Technical publication TP-22, PZT-5H was selected as ceramic phase. The polymer phase was constituted of Dow, which has a relatively high shear wave velocity, based on information provided by W. Smith and B. Auld, in “Modeling 1-3 Composite Piezoelectrics: Thickness-Mode Oscillations” IEEE Trans. on Ultrason. Ferrolec. Freq. Contr., vol. 38, no. 1, pp 40-47, 1991. This selection was done to reduce parasitic modes due to lateral waves.

As shown in FIG. 9, the transducer was designed with two piezocomposite layers with opposite polarization and 330 μm thickness each. A piezocomposite material with a 55.42% piezoelectric volume fraction of ceramics was selected in order to have a high coupling factor and no lateral waves in the desire range of frequency. Its coupling factor and mechanical impedance for the piezocomposite are 0.66 and 18.8 MRayl. The matching layer was made of Hysol—Alumina 0-3 composite with 20% Alumina fraction volume as described by M. Draheim and W. Cao in “Finite element analysis impedance matching layer thickness”, IEEE, Inter. Ultrason., Symp., pp 1015-1017, 1996. The thickness was 50 μm and it was diced in the elevation direction. The resulting kerf was filled with polyethylene. Electrodes were made with 2 μm thickness of gold. The transducer was air backed.

Focus points were simulated to cover a path inside the ROI so as to generate radiation forces at several points (up to 8), simultaneously.

Let P on FIG. 6 be the focus point. The unit vector \vec{u} defines the radiation force (and acoustic axis) direction. P₀ is a point located at the center of a transducer element so that P₀P is parallel to the acoustic axis. In the present example, the f-number was selected to 2. Let Pᵢ be the central point of a given transducer element of the ultrasound aperture including P₀. Variables r, r₀ and rᵢ are vectors, which represent positions of points P, P₀ and Pᵢ. The electrical potential φᵢ of the transducer element located at Pᵢ (i.e., a possible apodization scheme) is given in the frequency domain by:

$${Φ}_{i} = {Φ}_{0} \{ \frac{1}{4} \frac{{\vert {\underline{r}}_{i} - {\underline{r}}_{0} \vert}^{2}}{\vert \underline{r} - {\underline{r}}_{0} \vert} + 1 \} {e}^{- j k ( \vert {\underline{r}}_{i} - \underline{r} \vert - \vert {\underline{r}}_{0} - \underline{r} \vert )} \qquad ( 3 )$$

In equation (3), φ₀ is the electrical potential of the transducer element located at P₀, |rⱼ−r₀| is the distance between transducer elements i and 0, |r−rᵢ| is the distance between the focus point of transducer elements i, and k is the wave number of longitudinal waves in the radiating medium. Accordingly, the boundary integral representation of the acoustic field is given by:

$$p ( \underline{x} ) = ρ {ω}^{2} {u}_{n} {\sum }_{i = 1}^{2048} {Φ}_{i} {\int }_{{Γ}_{i}}^{ } G ( \underline{x} , {\underline{x}}^{′} ) d {S}_{{\underline{x}}^{′}} \qquad ( 4 )$$

Where ρ is the medium density, ω is the angular frequency. uₙ is the average normal displacement of each transducer element. G is the half-space rigid baffle acoustic Green's function. Γᵢ is the transducer i active area. p(x) is the resulting pressure at position x. As the problem is linear, φ₀ is fixed to target the acoustic intensity at the focus point.

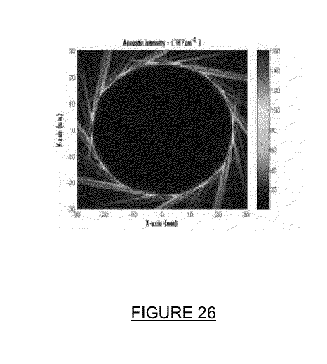

An example of focalization is presented in FIG. 26, for a circular path of 25 mm radius with 16 focalization points. The targeted local acoustic intensity is 160 W/cm². This simulation was done with a f-number of 2.

FIG. 26 shows results of acoustic intensity concentration along the desired path. Each focal zone was about 1 mm×8 mm. The internal normalized pressure was about −20 dB to −30 dB and the external normalize pressure was −10 dB. Electrical potentials of transducers ranged from 0.5 volt to 1.1 volt.

The transducers were optimized for a central frequency of 4.3 MHz; they were able to deliver enough power and generate the radiation force with a relatively low level of voltage excitation. Magnitude and orientation of the acoustic intensity (radiation force) at any point of a path were controlled.

The present device, system and method have been described by way of preferred embodiments. It should be clear to those skilled in the art that the described preferred embodiments are for exemplary purposes only, and should not be interpreted to limit the scope of the present device, system and method. The device, system and method as presented in the description of preferred embodiments can be modified without departing from the scope of the appended claims, which clearly delimit the protection sought.

1. A method for generating radiation forces in a region of interest, the method comprising:
identifying a plurality of additive shear waves;
determining direction and magnitude of two-dimensional acoustic waves for each additive shear wave; and
generating the two-dimensional acoustic waves with the determined direction and magnitude for each one of the plurality of additive shear waves so as to generate radiation forces in the region of interest.

2. The method of claim 1, wherein the plurality of additive shear waves are generated concurrently.

3. The method of claim 2, wherein the additive shear waves converge to one specific point in the region of interest.

4. The method of claim 2, wherein the additive shear waves follow an arbitrary path in the region of interest.

5. The method of claim 2, wherein the additive shear waves surround the region of interest.

6. A system for generating radiation forces in a region of interest, the system comprising:
a plurality of transducers for generating two-dimensional acoustic waveforms; and
a control unit for controlling orientation and magnitude of the two-dimensional radiation forces so as to generate a plurality of additive shear waves in the region of interest.

7. The system of claim 6, wherein the additive shear waves are generated concurrently.

8. The system of claim 7, wherein the additive shear waves converge to one specific point in the region of interest.

9. The system of claim 7, wherein the additive shear waves follow an arbitrary path in the region of interest.

10. The system of claim 7, wherein the additive shear waves surround the region of interest.

11. A device for generating radiation forces in a region of interest, the device comprising:
a plurality of transducers, each transducer being controlled for generating a two-dimensional acoustic radiation force with a corresponding orientation and magnitude so as to generate additive shear waves in the region of interest.

12. The device of claim 11, wherein the additive shear waves are concurrent and converge to one specific point in the region of interest.

13. The device of claim 11, wherein the additive shear waves follow an arbitrary path in the region of interest.

14. The device of claim 11, wherein the additive shear waves surround the region of interest.
